(19) United States
(12) Patent Application Publication
(10) Pub. No.: US 2024/0094471 A1
(43) Pub. Date: Mar. 21, 2024

(54) COLLIMATION FIBER ADAPTER

(71) Applicant: Shphotonics Ltd, Suzhou (CN)

(72) Inventors: Haifeng CHEN, Shenzhen (CN); Lei SUN, Suzhou (CN)

(21) Appl. No.: 18/457,732

(22) Filed: Aug. 29, 2023

(30) Foreign Application Priority Data
Sep. 15, 2022 (CN) 202222468300.5

(51) Int. Cl. G02B 6/38

(52) U.S. Cl. CPC G02B 6/3825; G02B 6/3853

(57) ABSTRACT

A collimation fiber adapter includes a base, a metasurface collimation lens, a sleeve, and a fiber ferrule. The base includes a mounting cavity with a positioning structure at an end of the mounting cavity. The metasurface collimation lens is connected to the positioning structure. The sleeve is arranged inside the mounting cavity. An end of the sleeve away from the positioning structure is configured to assemble a fiber. The fiber ferrule is arranged inside the mounting cavity and assembled with an end of the sleeve close to the positioning structure. A first side end surface of the fiber ferrule away from the positioning structure is configured to be coupled with the fiber. A second side end surface of the fiber ferrule close to the positioning structure is opposite to the metasurface collimation lens.

### CROSS-REFERENCE TO RELATED APPLICATION

This application claims priority to Chinese Application No. 202222468300.5, filed on Sep. 15, 2022, the entire content of which is incorporated herein by reference.

### TECHNICAL FIELD

The present disclosure relates to the optical communication technology field and, in particular, to a collimation fiber adapter and a fiber transceiver.

### BACKGROUND

An optical module includes a fiber transceiver, a functional circuit, and an optical interface. The fiber transceiver includes an emission member and a reception member. The emission member is configured to convert an electrical signal into an optical signal. The reception member is configured to convert an optical signal into an electrical signal.

In the fiber transceiver, to facilitate optical path design and perform wave separation and wave combination on the optical signal, the optical path needs to be designed as a parallel path. Thus, a collimation fiber adapter needs to be arranged at a fiber coupling location.

The coupling efficiency and applicability of the collimation fiber adapter need to be improved.

### SUMMARY

Embodiments of the present disclosure provide a collimation fiber adapter, including a base, a metasurface collimation lens, a sleeve, and a fiber ferrule. The base includes a mounting cavity with a positioning structure at an end of the mounting cavity. The metasurface collimation lens is connected to the positioning structure. The sleeve is arranged inside the mounting cavity. An end of the sleeve away from the positioning structure is configured to assemble a fiber. The fiber ferrule is arranged inside the mounting cavity and assembled with an end of the sleeve close to the positioning structure. A first side end surface of the fiber ferrule away from the positioning structure is configured to be coupled with the fiber. A second side end surface of the fiber ferrule close to the positioning structure is opposite to the metasurface collimation lens. A distance between the second side end surface and the metasurface collimation lens matches a focal length of the metasurface collimation lens.

Embodiments of the present disclosure provide a fiber transceiver, including a collimation fiber adapter. The collimation fiber adapter includes a base, a metasurface collimation lens, a sleeve, and a fiber ferrule. The base includes a mounting cavity with a positioning structure at an end of the mounting cavity. The metasurface collimation lens is connected to the positioning structure. The sleeve is arranged inside the mounting cavity. An end of the sleeve away from the positioning structure is configured to assemble a fiber. The fiber ferrule is arranged inside the mounting cavity and assembled with an end of the sleeve close to the positioning structure. A first side end surface of the fiber ferrule away from the positioning structure is configured to be coupled with the fiber. A second side end surface of the fiber ferrule close to the positioning structure is opposite to the metasurface collimation lens. A distance between the second side end surface and the metasurface collimation lens matches a focal length of the metasurface collimation lens.

### BRIEF DESCRIPTION OF THE DRAWINGS

FIG. 1 is a schematic diagram showing an internal structure of a collimation fiber adapter according to some embodiments of the present disclosure.

FIG. 2 is a schematic cross-section structural diagram of a collimation fiber adapter along an axial direction according to some embodiments of the present disclosure.

FIG. 3 is a schematic structural diagram showing an end side of a collimation fiber adapter (along direction A in FIG. 2) according to some embodiments of the present disclosure.

FIG. 4 is a schematic cross-section structural diagram of a collimation fiber adapter along direction B-B in FIG. 2 according to some embodiments of the present disclosure.

Reference numerals:

| | | |
|---|---|---|
| 001 Collimation fiber adapter | 012 Collimation lens | 013 Sleeve |
| 014 Fiber ferrule | | |
| 100 Collimation fiber adapter | 110 Base | 111 Mounting cavity |
| 112 Positioning structure | 120 Metasurface collimation lens | 130 Sleeve |
| 140 Fiber ferrule | 1110 Positioning groove | 1210 Substrate |
| 1211 Nanostructure layer | 1212 Nanostructure unit | 1101 First member |
| 1102 Second member | 1103 Mounting groove | 1104 Chamfer |

### DETAILED DESCRIPTION OF THE EMBODIMENTS

In the following, some example embodiments are described. As those skilled in the art would recognize, the described embodiments can be modified in various manners, all without departing from the spirit or scope of the present disclosure. Accordingly, the drawings and descriptions are illustrative in nature and not limiting.

In the present disclosure, terms such as “first,” “second,” and “third” can be used to describe various elements, components, regions, layers, and/or parts. However, these elements, components, regions, layers, and/or parts should not be limited by these terms. These terms are only used to distinguish one element, component, region, layer, or part from another element, component, region, layer, or layer. Therefore, a first element, component, region, layer, or part discussed below can also be referred to as a second element, component, region, layer, or part, which does not constitute a departure from the teachings of the present disclosure.

A term specifying a relative spatial relationship, such as “below,” “beneath,” “lower,” “under,” “above,” or “higher,” can be used in the disclosure to describe the relationship of one or more elements or features relative to other one or more elements or features as illustrated in the drawings. These relative spatial terms are intended to also encompass different orientations of the device in use or operation in addition to the orientation shown in the drawings. For example, if the device in a drawing is turned over, an element described as “beneath,” “below,” or “under” another element or feature would then be “above” the other element or feature. Therefore, an example term such as “beneath” or “under” can encompass both above and below. Further, a term such as “before,” “in front of,” “after,” or “subsequently” can similarly be used, for example, to indicate the order in which light passes through the elements. A device can be oriented otherwise (e.g., being rotated by 90 degrees or being at another orientation) while the relative spatial terms used herein still apply. In addition, when a layer is referred to as being “between” two layers, it can be the only layer between the two layers, or there can be one or more intervening layers. In this disclosure, if a light beam encounters a first element and then reaches a second element, the second element is referred to as being downstream the first element or downstream the first element in an optical path, and correspondingly the first element is referred to as being upstream the second element or upstream the second element in the optical path.

Terminology used in the disclosure is for the purpose of describing the embodiments only and is not intended to limit the present disclosure. As used herein, the terms “a,” “an,” and “the” in the singular form are intended to also include the plural form, unless the context clearly indicates otherwise. Terms such as “comprising” and/or “including” specify the presence of stated features, entities, steps, operations, elements, and/or parts, but do not exclude the existence or addition of one or more other features, integers, steps, operations, elements, parts, and/or combinations thereof. As used herein, the term “and/or” includes any and all combinations of one or more of the listed items. The phrases “at least one of A and B” and “at least one of A or B” mean only A, only B, or both A and B.

When an element or layer is referred to as being “on,” “connected to,” “coupled to,” or “adjacent to” another element or layer, the element or layer can be directly on, directly connected to, directly coupled to, or directly adjacent to the other element or layer, or there can be one or more intervening elements or layers. In contrast, when an element or layer is referred to as being “directly on,” “directly connected to,” “directly coupled to,” or “directly adjacent to” another element or layer, then there is no intervening element or layer. “On” or “directly on” should not be interpreted as requiring that one layer completely covers the underlying layer.

In the disclosure, description is made with reference to schematic illustrations of example embodiments (and intermediate structures). As such, changes of the illustrated shapes, for example, as a result of manufacturing techniques and/or tolerances, can be expected. Thus, embodiments of the present disclosure should not be interpreted as being limited to the specific shapes of regions illustrated in the drawings, but are to include deviations in shapes that result, for example, from manufacturing. Therefore, the regions illustrated in the drawings are schematic and their shapes are not intended to illustrate the actual shapes of the regions of the device and are not intended to limit the scope of the present disclosure.

Unless otherwise defined, all terms (including technical and scientific terms) used herein have the same meaning as commonly understood by those of ordinary skill in the art to which this disclosure belongs. Terms such as those defined in commonly used dictionaries should be interpreted to have meanings consistent with their meanings in the relevant field and/or in the context of this disclosure, unless expressly defined otherwise herein.

As used herein, the term “substrate” can refer to the substrate of a diced wafer, or the substrate of an un-diced wafer. Similarly, the terms “chip” and “die” can be used interchangeably, unless such interchange would cause conflict. The term “layer” can include a thin film, and should not be interpreted to indicate a vertical or horizontal thickness, unless otherwise specified.

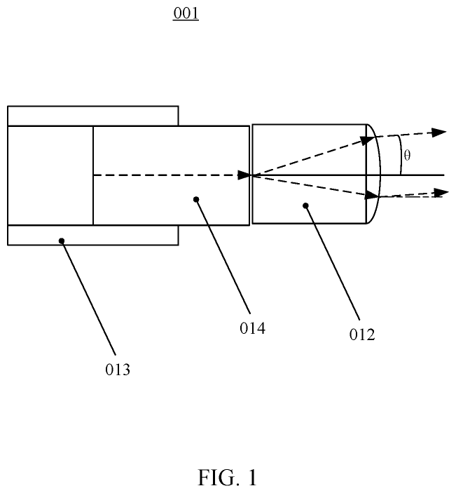

In some embodiments, as shown in FIG. 1, a collimation fiber adapter 001 includes a sleeve 013, a fiber ferrule 014, and a collimation lens 012 that are aligned coaxially. An end of the sleeve 013 is inserted in the fiber ferrule 014. The other end of the sleeve 013 can be inserted into a fiber (not shown). The collimation lens 012 can be a curved surface lens and can be configured to collimate light.

The above technical solution can have the following disadvantages. A coaxial accuracy of the fiber ferrule 014 and the collimation lens 012 can be hard to ensure. A maximum error can reach 20 μm. Thus, a maximum point accuracy of the collimation fiber adapter 001 (i.e., an included angle between emitted light beam and an axis of the collimation fiber adapter 001) can be 1 degree, which impacts the coupling efficiency of the collimation fiber adapter 001 (i.e., a ratio of energy of emitted light and energy of received light of the collimation fiber adapter 001). Because of the structural characteristic of the collimation lens 012, the collimation fiber adapter 001 is not suitable for small-size design, and cannot be applied to a compact fiber transceiver with a high transmission speed.

Embodiments of the present disclosure provide a collimation fiber adapter with improved coupling efficiency and applicability, and a fiber transceiver.

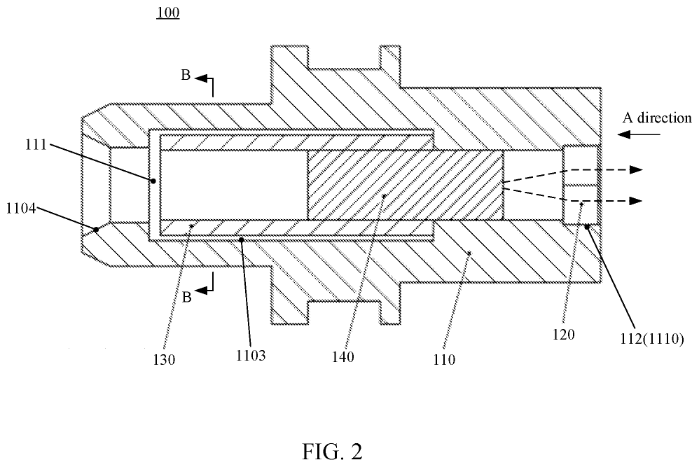

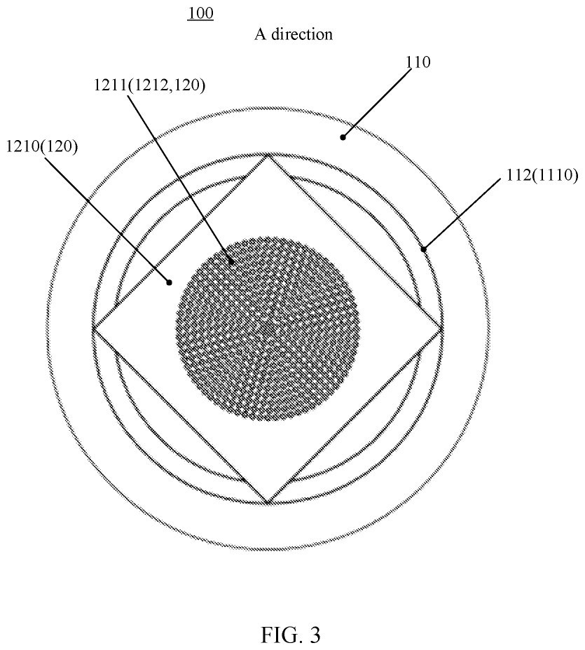

As shown in FIG. 2 and FIG. 3, the collimation fiber adapter 100 of embodiments of the present disclosure includes a base 110, a metasurface collimation lens 120, a sleeve 130, and a fiber ferrule 140. The base 110 includes a mounting cavity 111. One end of the mounting cavity 111 includes a positioning structure 112. The metasurface collimation lens 120 can be cooperatively connected to the positioning structure 112. The sleeve 130 is arranged within the mounting cavity 111. An end of the sleeve 130 that is far away from the positioning structure 112 can be configured to be assembled with the fiber (not shown). The fiber ferrule 140 is arranged within the mounting cavity 111 and is assembled with an end of the sleeve 130 that is close to the positioning structure 112. An end surface (distal end surface) of the fiber ferrule 140 that is far away from the positioning structure 112 can be configured to be optically coupled with the fiber. An end surface (proximal end surface) of the fiber ferrule 140 that is close to the positioning structure 112 can be opposite to the metasurface collimation lens 120. A distance between the end of the fiber ferrule 140 that is close to the positioning structure 112 and the metasurface collimation lens 120 can match a focus length of the metasurface collimation lens 120. For example, the distance can be equal to the focus length.

Metasurface refers to an artificial two-dimensional material. A basic structure unit of metasurface is a nanostructure unit with a size in an order of nanometers and smaller than a working wavelength. Metasurface can realize flexible and effective control of the characteristics, such as propagation direction, polarization mode, amplitude, and phase, of electromagnetic waves. Metasurface can also have an ultra-light characteristic. A metasurface optical device made based on the metasurface device can have good optical performance, small volume, and high integration compared to a conventional optical device. A metalens can be an optical device based on metasurface technology in a plane shape.

In embodiments of the present disclosure, the metasurface collimation lens 120 based on a metasurface design is provided. As shown in FIG. 3, the metasurface collimation lens 120 includes a substrate 1210 and a nanostructure layer 1211 arranged on one or two sides of the substrate 1210. The nanometer structure layer 1211 includes a plurality of nanostructure units 1212 arranged in a circular array. The center of the substrate 1210 coincides with the center of the nanostructure layer 1211. As shown in FIG. 2, by controlling the light through the nanostructure layer 1211, the light transmitted through the fiber ferrule 140 can be converted into collimated parallel light.

The collimation fiber adapter 100 of embodiments of the present disclosure includes the metasurface collimation lens 120 based on the metasurface design. Compared to the related technology, on the one hand, a device consistent with the disclosure can have a smaller axial size and a more compact structure. On another hand, the lens structure in the plane shape can be easily assembled with the positioning structure 112 at high accuracy. Thus, the collimation fiber adapter 100 can be aligned with the axial direction of the fiber ferrule 140. In some embodiments, a coaxial accuracy error between the fiber ferrule 140 of the collimation fiber adapter 100 and the metasurface collimation lens 120 can be controlled to be within 5 μm, and the point accuracy of the collimation fiber adapter 100 can be controlled to be within 0.3 degree, which is significantly improved compared to the related technology.

The collimation fiber adapter 100 of embodiments of the present disclosure has a relatively high coaxial assembly accuracy, and the accurate optical control effect can be obtained based on the optical control design of the metasurface collimation lens 120. Thus, the coupling efficiency of the collimation fiber adapter 100 can be significantly improved. In addition, since the structure of the collimation fiber adapter 100 can be flexibly adjusted based on the optical control design of the metasurface collimation lens 120, the collimation fiber adapter 100 can be applied to various types of fiber transceivers. Thus, the applicability can be greatly improved. The collimation fiber adapter can be particularly suitable for being applied to a compact fiber transceiver for high-speed transmission or a fiber transceiver with a long optical path design. The collimation fiber adapter can be suitable for mass production.

In embodiments of the present disclosure, the base 110 can be a mounting base configured to provide support, positioning, and mounting space for the metasurface collimation lens 120, the sleeve 130, and the fiber ferrule 140. The base 110 can be a metal piece and have an effect of shielding external electromagnetic interference.

As shown in FIG. 2, in some embodiments, the base 110 has a chamfer 1104 at another end of the mounting cavity 111 (i.e., the end opposite to the positioning structure 112) to facilitate the fiber to be inserted from the end into the mounting cavity 111. Then, the fiber can be inserted into the sleeve 130 to be optically coupled with the end surface of the fiber ferrule 140. The fiber ferrule 140 can be a ceramic fiber ferrule in a cylindrical shape and can be configured to guide the light to transmit in the fiber ferrule 140.

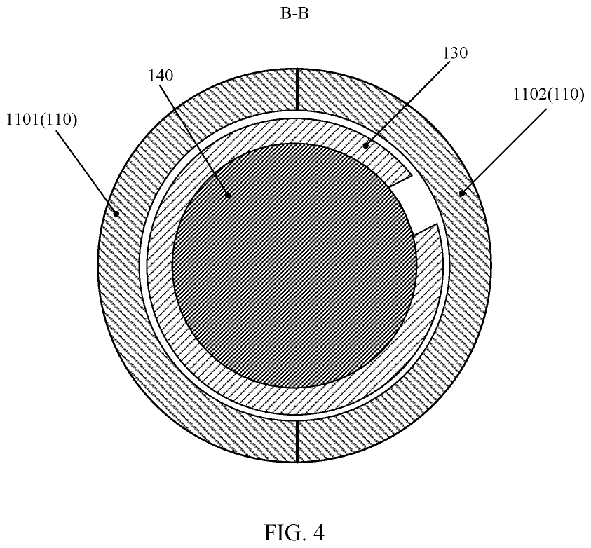

In some embodiments of the present disclosure, as shown in FIG. 4, the base 110 includes a first member 1101 and a second member 1102 that are detachably connected and enclose to form the above mounting cavity 111. Inner sides of the first member 1101 and the second member 1102 include mounting grooves 1103, respectively. The sleeve 130 can be arranged in the mounting grooves 1103 of the first member 1101 and the second member 1102, which facilitates the base 110 to be mounted with the sleeve 130 and ensures the mounting accuracy of the sleeve 130. The first member 1101 and second member 1102 can be prepared separately and then welded, bonded, or connected together by a fastener.

As shown in FIG. 4, in some embodiments, the sleeve 130 is a C-shaped opening ceramic sleeve. The fiber ferrule 140 and the sleeve 130 can have an interference fit. In embodiments of the present disclosure, the sleeve 130 can be designed to have an outer diameter slightly smaller than an inner diameter of the mounting cavity 111, which is assembled with the sleeve 130, and greater than the outer diameter of the fiber ferrule 140. When the fiber ferrule 140 is assembled with the sleeve 130 in the interference fit, the fiber ferrule 140 can slightly expand the outer diameter of the sleeve 130. An outer wall of the sleeve 130 can have an interference fit with an inner wall of the mounting cavity 111. In some embodiments, to facilitate installation, the outer wall of the sleeve 130 and the inner wall of the mounting cavity 111 can also have a clearance fit. In some other embodiments of the present disclosure, the sleeve can also be a closed ceramic sleeve, which is assembled with the fiber ferrule 140 in an interference fit.

In some embodiments, to fix the fiber ferrule 140 and the sleeve 130 reliably, the fiber ferrule 140 and the sleeve 130 can also be fixedly connected (e.g., by glue).

The coaxial degree of the fiber and the fiber ferrule 140 can be controlled to be within 1 μm based on the dimension design of the precision structure of the sleeve 130 and the fiber ferrule 140. Thus, the sleeve 130 and the fiber ferrule 140 can have a high coupling efficiency (i.e., the ratio between the energy of the light received by the fiber ferrule 140 and the energy of the light emitted by the fiber).

In embodiments of the present disclosure, a specific structural form of the positioning structure 112 is not limited. As shown in FIG. 2 and FIG. 3, in some embodiments, the positioning structure 112 is a positioning groove 1110. A sidewall of the positioning groove 1110 can be configured to perform circumferential positioning on the metasurface collimation lens 120, and a bottom wall of the positioning groove 1110 and the metasurface collimation lens 120 can be fixedly connected (e.g., by glue). The metasurface collimation lens 120 can be patched to and fixed in the positioning groove 1110 by using a patch machine and image recognition technology. Thus, the metasurface collimation lens 120 can be axially aligned to the fiber ferrule 140 at a high accuracy. In the related technology, since the collimation fiber adapter adopts a conventional collimation lens, a patching process is not suitable for mounting the collimation lens, which cannot reach the assembly accuracy by using the patching process.

In some embodiments of the present disclosure, the positioning groove 1110 is a circular positioning groove as shown in the figure. The substrate 1210 of the metasurface collimation lens 120 can be a square substrate. The whole metasurface collimation lens 120 can be square. The metasurface collimation lens 120 can be designed in a square shape, which facilitate cutting and mass production. The circular positioning groove can have a four-point positioning function for the metasurface collimation lens 120, which is square as a whole. Thus, the metasurface collimation lens 120 and the fiber ferrule 140 can be axially aligned with high accuracy.

In some embodiments, the positioning groove can also be a square annular positioning groove. The square annular positioning groove can be matched with the shape of the metasurface collimation lens that is square as the whole. Thus, the metasurface collimation lens and the fiber ferrule can also be aligned axially with high accuracy.

In some other embodiments of the present disclosure, the positioning structure can have other designs. For example, the positioning structure can include one or more positioning protrusions configured to match with an edge of the metasurface collimation lens, which can also achieve a relatively good positioning effect on the metasurface collimation lens.

Embodiments of the present disclosure further provide a fiber transceiver including a fiber collimation adapter consistent with the disclosure, such as the fiber collimation adapter 100 above. Since the coupling efficiency of the collimation fiber adapter 100 is improved, and the structure of the collimation fiber adapter 100 is designed to be compact, device performance of the fiber transceiver can be relatively good. The structure of the fiber transceiver can also be designed to be more compact.

Embodiments of the present disclosure further provide an optical module. The optical module can include the fiber transceiver above. Based on the collimation fiber adapter 100 above, the optical module can also have corresponding beneficial effects and better transmission performance.

For example, a fiber transceiver of a 100G or 400G optical module (a transmission rate of 100G or 400G) can adopt a collimation fiber adapter in the related technology, and a diameter of a collimation spot can range from 250 to 400 μm. Since errors of collimation degree and point accuracy are difficult to be ensured, the coupling efficiency of the wavelength laser device of the optical module and the stability of the whole product can be greatly influenced. If the collimation fiber adapter of embodiments of the present disclosure is adopted in the 100G or 400G optical module, the errors of the collimation degree and the point accuracy of the device can be obviously improved, and the coupling efficiency of the wavelength laser of the optical module can be correspondingly improved. Thus, the performance of the optical module product can be improved, the production process difficulty of the product can be reduced, and the production efficiency is improved.

In another example, a fiber transceiver of a Combo PON OLT optical module (Combo Passive Optical Network Optical Line Terminal) needs to separate two signals from an ONU Terminal (Optical Network Unit) with wavelengths of 1270 nm and 1310 nm in a coaxial device. Since the two wavelengths are very close, a non-collimated light beam can be difficult to be separated at a large angle by only using a filter. Thus, the collimation fiber adapter needs to be used to collimate the optical path. A diameter of a collimated light spot can generally range from 250 to 500 μm. In this example, the collimation fiber adapter can adopt a conventional C-lens. Since errors of the collimation degree and the point accuracy are large, the coupling efficiency of a laser device of 1490 nm and a laser device of 1577 nm can be low, the production yield can be low, and the product optical path can be unstable. If the collimation fiber adapter of embodiments of the present disclosure is applied in the Combo PON OLT optical module, the errors of the collimation degree and the point accuracy can be significantly improved. Thus, the coupling efficiency of the laser device of 1490 nm and the laser device of 1577 nm can be improved, which improves the performance of the optical module product, reduces the difficulty of the production process of the product, improves the production efficiency, and effectively improves the product competitiveness.

The specification provides different embodiments or examples of the present disclosure. These different embodiments and examples are exemplary and are not intended to limit the scope of the present disclosure in any manner. Those skilled in the art can think of various variations or replacements based on embodiments of the present disclosure. These variations or replacements are within the scope of the present disclosure. Thus, the scope of the present invention is subjected to the appended claims.

What is claimed is:

1. A collimation fiber adapter comprising:
a base including a mounting cavity with a positioning structure at an end of the mounting cavity;
a metasurface collimation lens connected to the positioning structure;
a sleeve arranged inside the mounting cavity, an end of the sleeve away from the positioning structure being configured to assemble a fiber; and
a fiber ferrule arranged inside the mounting cavity and assembled with an end of the sleeve close to the positioning structure, a first side end surface of the fiber ferrule away from the positioning structure being configured to be coupled with the fiber, a second side end surface of the fiber ferrule close to the positioning structure being opposite to the metasurface collimation lens, and a distance between the second side end surface and the metasurface collimation lens matching a focal length of the metasurface collimation lens.

2. The collimation fiber adapter according to claim 1, wherein:
the positioning structure includes a positioning groove; and
the metasurface collimation lens is fixedly connected to a bottom wall of the positioning groove.

3. The collimation fiber adapter according to claim 2, wherein the positioning groove includes a circular or square annular positioning groove.

4. The collimation fiber adapter according to claim 1, wherein the metasurface collimation lens includes:
a substrate; and
a nanostructure layer arranged on one or two sides of the substrate and including a plurality of nanostructure units arranged in a circular array, a center of the nanostructure layer coinciding with a center of the substrate.

5. The collimation fiber adapter according to claim 4, wherein:
the positioning structure includes a circular annular positioning groove; and
the substrate includes a square substrate.

6. The collimation fiber adapter according to claim 4, wherein a coaxiality between the metasurface collimation lens and the fiber ferrule is smaller than or equal to 5 μm.

7. The collimation fiber adapter according to claim 1, wherein the base includes a first member and a second member detachably connected to each other and enclosing to form the mounting cavity, mounting grooves being arranged on inner sides of the first member and the second member, and the sleeve being arranged in the mounting grooves of the first member and the second member.

8. The collimation fiber adapter according to claim 1, wherein another end of the mounting cavity includes a chamfer.

9. The collimation fiber adapter according to claim 1, wherein:
the sleeve includes a C-shaped opening ceramic sleeve or a closed ceramic sleeve; and
the fiber ferrule and an end of the sleeve close to the positioning structure have an interference fit.

10. A fiber transceiver comprising a collimation fiber adapter including:
a base including a mounting cavity with a positioning structure at an end of the mounting cavity;
a metasurface collimation lens connected to the positioning structure;
a sleeve arranged inside the mounting cavity, an end of the sleeve away from the positioning structure being configured to assemble a fiber; and
a fiber ferrule arranged inside the mounting cavity and assembled with an end of the sleeve close to the positioning structure, a first side end surface of the fiber ferrule away from the positioning structure configured to be coupled with the fiber, a second side end surface of the fiber ferrule close to the positioning structure being opposite to the metasurface collimation lens, and a distance between the second side end surface and the metasurface collimation lens matching a focal length of the metasurface collimation lens.

11. The fiber transceiver according to claim 10, wherein:
the positioning structure includes a positioning groove; and
the metasurface collimation lens is fixedly connected to a bottom wall of the positioning groove.

12. The fiber transceiver according to claim 11, wherein the positioning groove includes a circular or square annular positioning groove.

13. The fiber transceiver according to claim 10, wherein the metasurface collimation lens includes:
a substrate and
a nanostructure layer arranged on one or two sides of the substrate and including a plurality of nanostructure units arranged in a circular array, a center of the nanostructure layer coinciding with a center of the substrate.

14. The fiber transceiver according to claim 13, wherein:
the positioning structure includes a circular annular positioning groove; and
the substrate includes a square substrate.

15. The fiber transceiver according to claim 13, wherein a coaxiality between the metasurface collimation lens and the fiber ferrule is smaller than or equal to 5 μm.

16. The fiber transceiver according to claim 10, wherein the base includes a first member and a second member detachably connected to each other and enclosing to form the mounting cavity, mounting grooves being arranged on inner sides of the first member and the second member, and the sleeve being arranged in the mounting grooves of the first member and the second member.

17. The fiber transceiver according to claim 10, wherein another end of the mounting cavity includes a chamfer.

18. The fiber transceiver according to claim 10, wherein:
the sleeve includes a C-shaped opening ceramic sleeve or a closed ceramic sleeve; and
the fiber ferrule and an end of the sleeve close to the positioning structure have an interference fit.
